(19) United States
(12) Patent Application Publication
(10) Pub. No.: US 2024/0427379 A1
(43) Pub. Date: Dec. 26, 2024

(54) SLIDER STRUCTURE AND LOWER STRUCTURE OF DISPLAY UNIT OF FLEXIBLE DISPLAY MOBILE DEVICE

(71) Applicant: Sangkyu RYU, Uiwang-si (KR)

(72) Inventor: Sangkyu RYU, Uiwang-si (KR)

(21) Appl. No.: 18/721,173

(22) PCT Filed: Nov. 9, 2021
(86) PCT No.: PCT/KR2021/016256

§ 371 Date: Jun. 17, 2024

(30) Foreign Application Priority Data
Nov. 9, 2020 (KR) 10-2020-0148897
Dec. 17, 2020 (KR) 10-2020-0177247

(51) Int. Cl. G06F 1/16

(52) U.S. Cl. CPC G06F 1/1652; G06F 1/1624

(57) ABSTRACT

According to the effects of the present invention, the present invention minimizes an empty space upon separation of a display unit and a housing, generated as a slider unit-equipped flexible display unit of various types of folding-type terminals, rolling-type terminals, slider-type terminals, and wearable devices expands and retracts according to the expansion and retraction of the housing, prevents separation, overcomes a step difference due to sliding expansion, prevents screen wrinkles by closely adhering to various types of support parts, and minimizes a sense of difference when touched.

### TECHNICAL FIELD

The present invention relates to a lower structure and a slider structure of a display unit of a flexible display mobile device.

Furthermore, slider devices are applied to a wide variety form factors, including a folder-type terminals, rolling-type terminals, slider-type terminals, and wearable devices.

### BACKGROUND ART

Mobile devices equipped with flexible displays have been commercialized as folder-type terminals, and furthermore, slider-type structure and rolling-type terminals are being commercialized.

### DISCLOSURE

### Technical Problem

With the development of mobile devices equipped with flexible displays, a stable support structure of a screen is required according to the size of the screen during expansion and retraction. In addition to such a stable support structure, a screen is firmly integrated with the support structure to prevent the screen from being raised or wrinkled, and a stable structure of a display unit is required even for touch, input, and the like.

### Technical Solution

A stable coupling structure of a display unit and a slider housing is formed to prevent a screen from wrinkling, to provide a stable support structure, and to enable touching of the screen, thereby minimizing a separation space upon expansion and retraction of a mobile device equipped with a flexible display, and thus it is possible to smoothly input touching and the like and improve durability.

In general, a slider unit includes a slider support unit (103) that intersects a body housing (100) of a mobile device, in which when a slider expansion unit (101) of the mobile device expands, a screen expands as the slider support unit (103) intersecting on the body housing (100) of the mobile device moves to one side through a lead-out unit of a flexible display of a mobile device housing. When the slider expands, an empty space is formed in a portion that is created as the slider support unit (103) moves, and a flexible display unit is placed on the empty space while being led out through the lead-out unit (102) of the flexible display of the mobile device housing, and thus the housing and the flexible display unit are spaced apart from each other, and the empty space is formed at a lower end thereof, resulting in difficulty in work such as touching and possibility of inflow of foreign substances.

The flexible display unit, which is always exposed while being disposed on the slider support unit before expansion, does not need to be flexible, so that the flexible display unit is cured and disposed so as to be resistant to scratches.

The flexible display unit exposed to an outside of the mobile device is formed in a rigid form, and the flexible display unit accommodated in an accommodation unit of the mobile device is formed in a flexible form.

The flexible display unit is coated with a material such as polyimide or glass, in which the flexible display unit that is always exposed is cured using the material such as polyimide or glass to have a form in which a rigid region and a flexible region are mixed.

As the accommodated flexible display is led out, in order to fill an empty space formed when the slider moves, a flexible display unit lower end protrusion (201) may extend from an end of the intersecting slider support unit (103), which moves upon expansion and retraction of the slider. The flexible display unit lower end protrusion (201) is formed in a straight line to move along a sliding direction by laying a flexible material on a lower end of the display unit and drawing out a part of the lower end. In this case, in order to allow the flexible display unit lower end protrusion (201) to rotate along the rotary roll (104) together with the flexible display unit, a small groove is formed in perpendicular to a rotation direction of a rotary roll (104), so that the flexible display unit lower end protrusion (201) may naturally lead in or lead out along a curve at a curved section, and the flexible display unit lower end protrusion (201) may be formed of various materials such as a flexible material, a wire, a caterpillar track, a nanotube, or a silver nanowire alone or in combination. The flexible display unit lower end protrusion (201) is exposed to the outside of the slider body through the rotary roll (104) when the flexible display unit lower end protrusion (201) is led into or led out of the slider body (100) in a U shape or roll shape according to a sliding operation by connectively attaching a slider lead-out unit (100) or body (100) of the slider mobile device or adding a fixing device (202) of the flexible display unit lower end protrusion.

The flexible display unit lower end protrusion may be manufactured together with the flexible display or separately manufactured from the flexible display to be combined when the mobile device is manufactured.

The rotary roll (104) of the flexible display may not be provided in the form of a large cylindrical shape, in which only a half of the rotary roll (104) corresponding to the semicircle of the rounded rotary roll (104) is used to allow a small auxiliary roll (104c) to be inserted into an outer surface of the semicircle portion. Such a structure makes an internal space of the body housing (100) of the mobile device more widely used, thereby facilitating design according to the arrangement of components.

The rotary roll (104) of the flexible display may have an unevenness structure, and the flexible display unit lower end protrusion (201) may be led in or led out while being coupled to an unevenness groove of a small unevenness roll (104e) having a caterpillar shape (201c) and an unevenness groove (201d) formed in the caterpillar shape (201c).

The flexible display unit lower end protrusion (201) may be directly connected to a wire, a line, a carbon nanotube, or the like to take on a significant portion of tension generated during lead-in and lead-out of the flexible display.

Such a plurality of structures such as unevenness structures and wires enhances durability of the flexible display unit by allowing a force to be evenly distributed during manual expansion or retraction of the slider.

In addition, when the led-in flexible display is led out, the flexible display unit lower end protrusion (201) may have different thickness and height in order to adjust a step difference that occurs when the slider structure has multiple layers and a plurality of slider structures are provided.

The display unit, which is accommodated in the housing of the mobile device in various forms such as a roll shape, a U shape, and the like may be led out or led in through the lead-out unit (102) of the flexible display of the mobile device housing according to the expansion of the slider of the mobile device. In this case, the empty space formed when the slider support unit (103) moves along a guide unit is filled with the flexible display unit lower end protrusion (201), and the flexible display unit lower end protrusion (201) extends to be coupled with the slider support unit (103) to prevent the screen from being separated. Obviously, the slider support unit (103) or the flexible display unit lower end protrusion (201) is slid through a groove structure of the guide unit so as not to escape from a guide. In some cases, the slider support unit (103) has lead-out units of the flexible display of the mobile device housing, which are disposed at both sides of the mobile device, and in this case, the lead-out units are led out or led in in the form in which the empty space between the slider support units (103) is filled with the flexible display unit lower end protrusion (201) that extends to be connected with the body housing (100) of the mobile device.

When one slider expansion unit (101) of the flexible display mobile device is provided, the slider support unit (103) may have slider support units (103a) having different positions, and may be led out of and led into a slider outlet (103b) formed in the body housing (100) of the flexible display mobile device. This structure has durability against vertical impact of the flexible display mobile device.

Such a form may be applied to all places in which the form of the slider structure is applied, such as a folding-type terminal, a rolling-type terminal, a slider-type terminal, a wearable device, and the like, and may be produced in parallel with various types of additional slider structures.

### Advantageous Effects

According to the effects of the present invention, it is possible to minimize an empty space upon separation of the display unit and the housing, which is formed as the flexible display unit of various types of folding-type terminals, rolling-type terminals, slider-type terminals, and wearable devices expands and retracts according to the expansion and retraction of the housing, to prevent the separation, to overcome a step difference due to sliding expansion, to prevent the screen from wrinkling by closely adhering to various types of support units, and to minimize a sense of difference upon touching.

### DESCRIPTION OF DRAWINGS

FIG. 1 is an internal structure view upon expansion of a sliding mobile device.

FIG. 2 is an exemplary view of a lower end structure of a flexible display unit.

FIG. 3 is an exemplary view of a lower slider support unit of the sliding mobile device.

FIG. 4 is a second exemplary view of the lower slider support unit of the sliding mobile device.

FIG. 5 is a front view of the lower slider support unit of the sliding mobile device.

FIG. 6 is an exemplary view of a flexible display unit lower end protrusion connected to the slider support unit or a slider body.

FIG. 7 is an exemplary view of a rolling structure of the sliding mobile device.

FIG. 8 is a structural view of a slider on both sides of the slider mobile device.

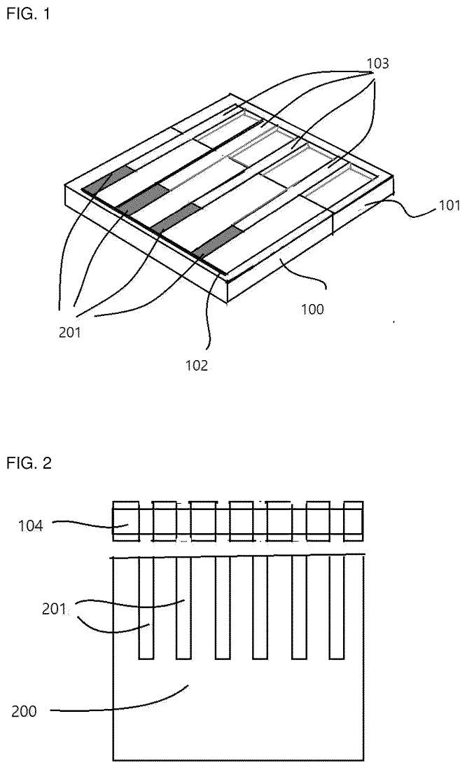

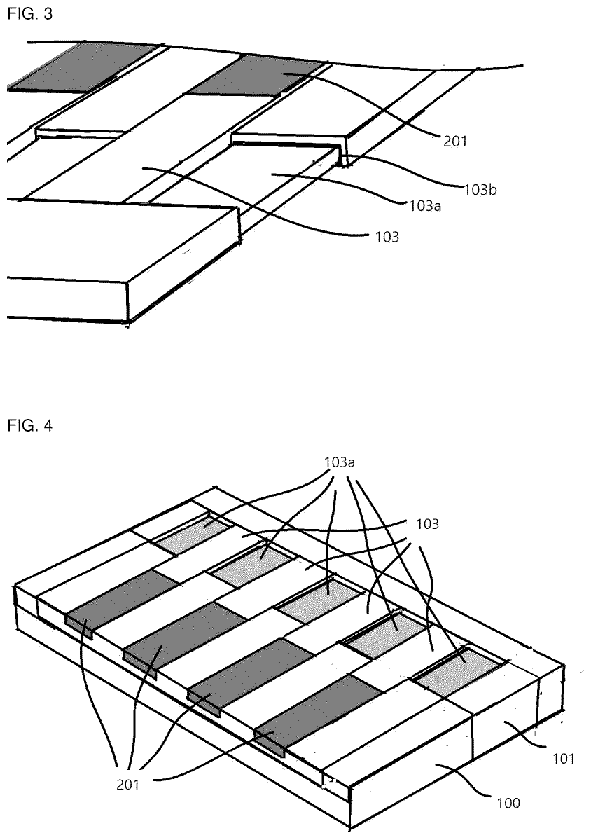

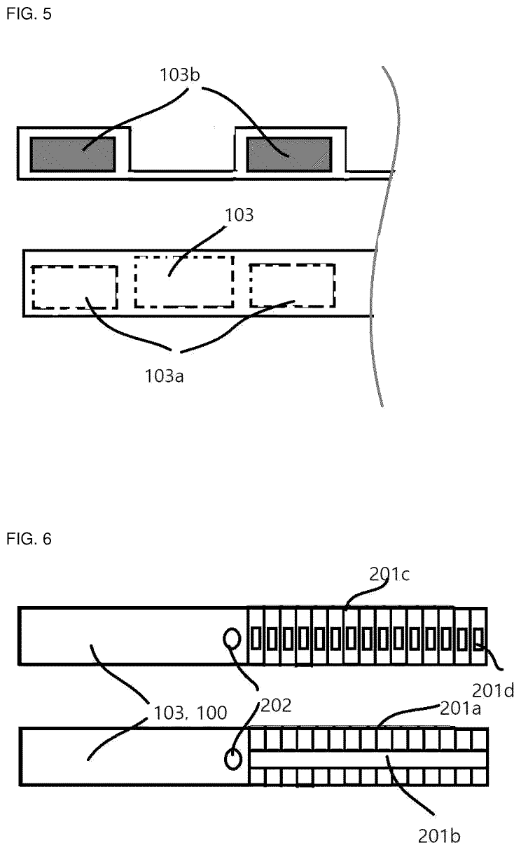

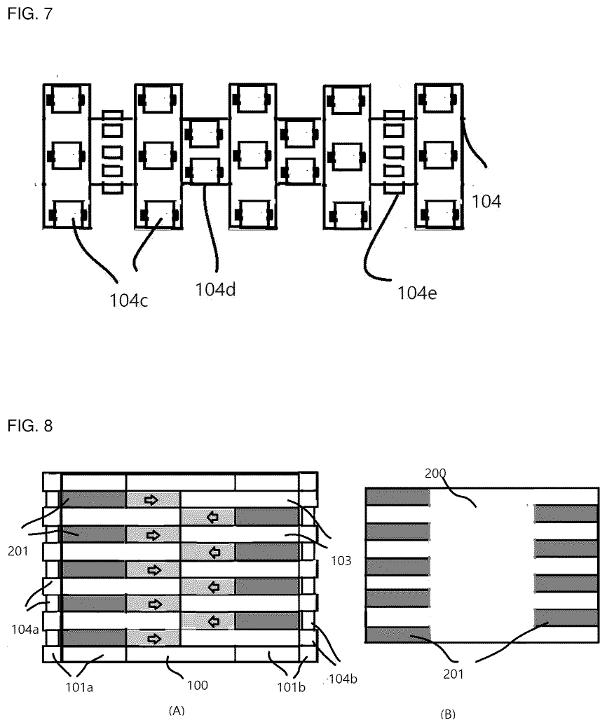

### MODE FOR INVENTION

A stable coupling structure of a display unit and a slider housing is formed to prevent a screen from wrinkling, to provide a stable support structure, and to enable touching of the screen, thereby minimizing a separation space upon expansion and retraction of a mobile device equipped with a flexible display, and thus it is possible to smoothly input touching and the like and improve durability.

In general, a slider unit includes a slider support unit 103 that intersects a body housing 100 of a mobile device, in which when a slider expansion unit 101 of the mobile device expands, a screen expands as the slider support unit 103 intersecting on the body housing 100 of the mobile device moves to one side through a lead-out unit of a flexible display of a mobile device housing. When the slider expands, an empty space is formed in a portion that is created as the slider support unit 103 moves, and a flexible display unit is placed on the empty space while being led out through the lead-out unit 102 of the flexible display of the mobile device housing, and thus the housing and the flexible display unit are spaced apart from each other, and the empty space is formed at a lower end, resulting in difficulty in work such as touching and possibility of inflow of foreign substances.

The flexible display unit, which is always exposed while being disposed on the slider support unit before expansion, does not need to be flexible, so that the flexible display unit is cured and disposed so as to be resistant to scratches.

The flexible display unit exposed to an outside of the mobile device is formed in a rigid form, and the flexible display unit accommodated in an accommodation unit of the mobile device is formed in a flexible form.

The flexible display unit is coated with a material such as polyimide or glass, in which the flexible display unit that is always exposed is cured using the material such as polyimide or glass to have a form in which a rigid region and a flexible region are mixed.

As the accommodated flexible display is led out, in order to fill an empty space formed when the slider moves, a flexible display unit lower end protrusion 201 may extend from an end of the intersecting slider support unit 103, which moves upon expansion and retraction of the slider. The flexible display unit lower end protrusion 201 is formed in a straight line to move along a sliding direction by laying a flexible material on a lower end of the display unit and drawing out a part of the lower end. In this case, in order to allow the flexible display unit lower end protrusion 201 to rotate along the rotary roll 104 together with the flexible display unit, a small groove is formed in perpendicular to a rotation direction of a rotary roll 104, so that the flexible display unit lower end protrusion 201 may naturally lead in or lead out along a curve at a curved section, and the flexible display unit lower end protrusion 201 may be formed of various materials such as a flexible material, a wire, a caterpillar track, a nanotube, or a silver nanowire alone or in combination. The flexible display unit lower end protrusion 201 is exposed to the outside of the slider body through the rotary roll 104 when the flexible display unit lower end protrusion 201 is led into or led out of the slider body 100 in a U shape or roll shape according to a sliding operation by connectively attaching a slider lead-out unit 100 or body 100 of the slider mobile device or adding a fixing device 202 of the flexible display unit lower end protrusion.

The flexible display unit lower end protrusion may be manufactured together with the flexible display or separately manufactured from the flexible display to be combined when the mobile device is manufactured.

The rotary roll 104 of the flexible display may have an unevenness structure, and the flexible display unit lower end protrusion 201 may be led into or led out while being coupled to an unevenness groove of a small unevenness roll 104e having a caterpillar shape 201c and an unevenness groove 201d formed in the caterpillar shape 201c.

The flexible display unit lower end protrusion 201 may be directly connected to a wire, a line, a carbon nanotube, or the like to take on a significant portion of tension generated during lead-in and lead-out of the flexible display.

Such a plurality of structures such as unevenness structures and wires enhance durability of the flexible display unit by allowing a force to be evenly distributed during manual expansion or retraction of the slider.

In addition, when the led-in flexible display is lead out, the flexible display unit lower end protrusion 201 may have different thickness and height in order to adjust a step difference that occurs when the slider structure has multiple layers and a plurality of slider structures are provided.

The display unit, which is accommodated in the housing of the mobile device in various forms such as a roll shape, a U shape, and the like may be led out or led in through the lead-out unit 102 of flexible display of the mobile device housing according to the expansion of the slider of the mobile device. In this case, the empty space formed when the slider support unit 103 moves along a guide unit is filled with the flexible display unit lower end protrusion 201, and the flexible display unit lower end protrusion 201 extends to be coupled with the slider support unit 103 to prevent the screen from being separated. Obviously, the slider support unit 103 or the flexible display unit lower end protrusion 201 is slid through a groove structure of the guide unit so as not to escape from a guide. In some cases, the slider support unit 103 has lead-out units of the flexible display of the mobile device housing, which are disposed at both sides of the mobile device, and in this case, the lead-out units are led-out or led-in in the form in which the empty space between the slider support units 103 is filled with the flexible display unit lower end protrusion 201 that extends to be connected with the body housing 100 of the mobile device.

When one slider expansion unit 101 of the flexible display mobile device is provided, the slider support unit 103 may have other end slider support units 103a having different positions, and may be led out of and led into a slider outlet 103b formed in the body housing 100 of the flexible display mobile device. This structure has durability against vertical impact of the flexible display mobile device.

Such a form may be applied to all places in which the form is applied, such as a folding-type terminal, a rolling-type terminal, a slider-type terminal, a wearable device, and the like, and may be produced in parallel with various types of additional slider structures.

### INDUSTRIAL APPLICABILITY

According to the effects of the present invention, it is possible to minimize an empty space upon separation of the display unit and the housing, which is formed as the flexible display unit of various types of folding-type terminals, rolling-type terminals, slider-type terminals, and wearable devices expands and retracts according to the expansion and retraction of the housing, to prevent the separation, to overcome a step difference due to sliding expansion, to prevent the screen from wrinkling by closely adhering to various types of support units, and to minimize a sense of difference upon touching. Therefore, the present invention has industrial applicability.

100: body housing of mobile device 101: slider expansion unit of mobile device 101a: left side of slider expansion unit of mobile device 101b: right side of slider expansion unit of mobile device 102: lead-out unit of flexible display of mobile device housing 103: slider support unit 103a: other end slider support unit 103b: slider outlet 104: rotary roll 104a: left rotary roll 104b: right rotary roll 104c: auxiliary roll 104d: auxiliary roll of small roll 105e: small unevenness roll 200: lower end of flexible display unit 201: flexible display unit lower end protrusion 202: fixing device of lower end protrusion of flexible display unit

1. A lower structure and a slider structure of a display unit of a flexible display mobile device in a portable device equipped with a slider device, the lower structure and the slider structure comprising a flexible display unit lower end protrusion having a function of filling an empty space while interworking with a slider unit.

2. A lower structure and a slider structure of a display unit of a flexible display mobile device in a portable device equipped with a slider device, the lower structure and the slider structure comprising a plurality of slider units, wherein one slider unit is formed of multiple layers.
